(19) United States
(12) Patent Application Publication
(10) Pub. No.: US 2025/0198204 A1
(43) Pub. Date: Jun. 19, 2025

(54) DUAL LOCKING DOOR LATCH STRUCTURE OF VEHICLE

(71) Applicants: Hyundai Motor Company, Seoul (KR); Kia Corporation, Seoul (KR); PHA CO., LTD., Daegu (KR)

(72) Inventors: Gookhyun JEON, Hwaseong-Si (KR); Jaeseung LEE, Hwaseong-Si (KR); Byeong Gook LEE, Daegu (KR); Do Sik MOON, Daegu (KR); Jeong Han YOON, Daegu (KR)

(73) Assignees: Hyundai Motor Company, Seoul (KR); Kia Corporation, Seoul (KR); PHA CO., LTD., Daegu (KR)

(21) Appl. No.: 18/915,808

(22) Filed: Oct. 15, 2024

(30) Foreign Application Priority Data
Dec. 18, 2023 (KR) 10-2023-0184653

(51) Int. Cl. E05B 81/14; E05B 81/06; E05B 81/30; E05B 81/34; E05B 81/90; E05B 83/40

(52) U.S. Cl. CPC E05B 81/14; E05B 81/06; E05B 81/30; E05B 81/34; E05B 81/90; E05B 83/40

(57) ABSTRACT

A dual locking door latch structure of a vehicle includes: a claw rotating to be coupled to or decoupled from a striker provided on the door; a door pawl operating to rotate the claw by contacting or releasing the contact with the claw by the rotation; a release lever coupled to the door pawl and operating to rotate the door pawl by up and down movement of the release lever; a lead lever assembly coupled to the release lever and moving the release lever in up and down directions; a motor providing driving force to the lead lever assembly for the up and down movement of the lead lever assembly; and a gear assembly engaged between the motor and the lead lever assembly and transmitting the driving force provided by the motor to the lead lever assembly, in which the claw, the door pawl, and the release lever are provided in pairs on first and second sides of the lead lever assembly, respectively, and operate simultaneously.

### CROSS-REFERENCE TO RELATED APPLICATION

The present application claims priority to Korean Patent Application No. 10-2023-0184653 filed on Dec. 18, 2023, the entire contents of which is incorporated herein for all purposes by this reference.

### BACKGROUND OF THE PRESENT DISCLOSURE

### Field of the Present Disclosure

The present disclosure relates to a dual locking door latch structure of a vehicle, and more particularly, to a dual locking door latch structure of a vehicle, which is mounted on a vehicle body corresponding to a sliding door that slides forwards and backwards in a longitudinal direction of a vehicle to open or close a door opening of the vehicle body, and includes a cinching function.

### Description of Related Art

Generally, a vehicle has a compartment of a predetermined size in which a driver or his or her accompanying passengers may ride, and a compartment opening/closing door is provided on a vehicle body to open or close the compartment.

In the case of a passenger vehicle, the compartment opening/closing door includes a front door provided at the front in a longitudinal direction of a vehicle and a rear door provided at the rear in the longitudinal direction of the vehicle, and the front and rear doors are usually hinged to the vehicle body.

In the case of a van that many people may accommodate, the compartment opening/closing door is configured to open or close the compartment by sliding forwards and backwards in the longitudinal direction of the vehicle.

Since the compartment opening/closing door is configured to move backward in the longitudinal direction of the vehicle to open the compartment, but move forward in the longitudinal direction of the vehicle to close the compartment, the compartment opening/closing door includes the advantage in that a space required to open or close the door is smaller than that of a hinged compartment opening/closing door and that the door opening formed in the vehicle body may be completely open even in a narrow space required for opening and closing.

As illustrated in FIG. 1, in the present sliding compartment door, main latches P1 and P2 are formed at center portions of the front and rear doors, respectively. Furthermore, a latch structure is required even at an upper end portion and a lower end portion of the door to ensure door release strength, ceiling strength, etc., and a cinching function is also required to respond to an automatic opening/closing structure.

As illustrated in FIG. 3 and FIG. 4, the existing latch has a structure in which one latch can cinch and release only one door, and has a structure in which a cinching lever 14 operates with a cinching cable 12 by a motor connected to a cinching motor connection portion 10, a release lever 24 operates by a release cable 22 by a motor connected to a release motor connection portion 20, and a pawl 26 and a claw 16 rotate by these levers to be coupled to a striker of the door.

Furthermore, the existing latch may have a structure in which a pawl 39 and a claw 36 operate by a lever 34 and a cable 38 using a single cinching motor 30 and a gear 32.

In the existing latch structure described above, only one latch may be mounted on each door, and as a result, a large number of latch portions are required, so there is a problem in that the size is excessive and the latch invades into an indoor space when applied to a bi-directional open door. Therefore, as illustrated in FIG. 1 and FIG. 2, an attempt was made to install a latch structure 7 on the vehicle body between door drive units 3 and 5 in area ‘A’ and area ‘B’ of a vehicle body 1. However, there is a problem in that the space between the door drive units 3 and 5 is narrow, the weight and thickness of the door increases, and entry and exit ability is poor due to the latch structure 7.

Accordingly, there is a need to develop a latch structure that provides a cinching function with a minimized size in the vehicle body between the door drive units 3 and 5.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a bi-directional dual locking door latch structure integrated with a cinching actuator which is mounted on a vehicle body to lock and release a bi-directional sliding door.

According to an exemplary embodiment of the present disclosure, a dual locking door latch structure of a vehicle, which is provided on a vehicle body to open or close a door configured to open or close a door opening of the vehicle, and is provided to be coupled to or decoupled from the door includes: a claw rotating to be coupled to or decoupled from a striker provided on the door; a door pawl operating to rotate the claw by contacting or releasing the contact with the claw by the rotation; a release lever coupled to the door pawl and operating to rotate the door pawl by up and down movement of the release lever; a lead lever assembly coupled to the release lever and moving the release lever in up and down directions; a motor providing driving force to the lead lever assembly for the up and down movement of the lead lever assembly; and a gear assembly engaged between the motor and the lead lever assembly and transmitting the driving force provided by the motor to the lead lever assembly, in which the claw, the door pawl, and the release lever are provided in pairs on first and second sides of the lead lever assembly, respectively, and operate simultaneously.

The release lever may be attached to a center portion of the lead lever assembly, extend to both sides of the lead lever assembly, and connected to the door pawl.

The dual locking door latch structure of a vehicle may further include an emergency link assembly connected to the release lever and moving the release lever and the lead lever assembly upward by rotation thereof.

The emergency link assembly may be connected to an emergency cable and operate manually.

The emergency cable may be connected to an emergency lever separately provided on an exterior of the vehicle.

One side of the door pawl may be provided with an REF switch which is configured to detect a reference position of the door pawl and a pawl switch which is configured to detect a current position of the door pawl.

One side of the claw may be provided with a claw switch which is configured to detect a current position of the claw.

One side of the lead lever assembly may be provided with a home pose switch which is configured to detect the current position of the lead lever assembly.

The claw and the lead lever assembly may be movably fixed to a base plate.

When the door is closed, the striker may be coupled to the claw to be in 1-stage locking, the lead lever assembly may be lowered by operation of the motor, the door pawl may rotate by the release lever, and the door pawl may contact with the claw and operate so that the claw rotates and cinches.

When the door is open, if an unlock signal is received, the lead lever assembly may move upward by operation of the motor, and the door pawl may rotate by the release lever, and if the door pawl releases the contact with the claw and the claw rotates, the claw may be decoupled from the striker.

When the claw releases the contact with the door pawl, the claw may return to its original position by elastic force.

When the emergency cable is pulled upward, the emergency link assembly may rotate to move the lead lever assembly upward, the door pawl rotates by the release lever, and the door pawl releases the contact with the claw and the claw rotates so that the claw is decoupled from the striker.

The dual locking door latch structure of a vehicle may be provided at upper and lower portions of the vehicle body of a door opening to be coupled to or decoupled from the front and rear doors of the vehicle, respectively, and the front and rear doors may be provided to open or close simultaneously or separately.

When the front and rear doors of the vehicle are open simultaneously, if an opening signal is received, the claw may be decoupled from the striker by operation of the motor, and the front and rear doors may move by operation of drive units provided in each thereof so that the door opening is open.

When the front and rear doors of the vehicle are closed simultaneously, if a closing signal of the front and rear doors is received, the claw may be decoupled from the striker by operation of the motor, the front and rear doors may move by operation of the drive units provided in each thereof so that the door opening is closed, the strikers provided on the front and rear doors, respectively, may be coupled to the claw to be in the 1-stage locking, and the claw may rotate by operation of the motor and may be simultaneously cinched.

When only the front door is open while the front and rear doors of the vehicle are closed, if the opening signal of the front door is received, the claw may be decoupled from the striker by operation of the motor provided on the front and rear doors, the door opening may be open by moving by operation of the drive unit on the front door side, and the claw may operate to rotate by operation of the motor.

When the rear door is open while only the front door of the vehicle is open, if the opening signal of the rear door is received, the claw may be decoupled from the striker by operation of the motor provided on the front and rear doors, and the door opening may be open by operation of the drive unit on the rear door side thereof.

When only the rear door is closed while the front and rear doors of the vehicle are open, if the closing signal of the rear door is received, the claw may be decoupled from the striker by operation of the motor provided on the front and rear doors, the door opening may move by operation of the drive unit on the rear door side so that the door opening is closed, the striker provided on the rear door may be coupled to the claw to be in the 1-stage locking, and the claw may rotate by operation of the motor and may be simultaneously cinched.

According to an exemplary embodiment of the present disclosure, by providing the bi-directional dual locking door latch structure of minimized size on the vehicle body between the door drive units to cinch and release the bi-directional sliding door, the bi-directional dual locking door latch structure may include four door latches compared to the existing eight door latches, so it is possible to reduce the material costs and reduce the thickness and weight.

Furthermore, since the size of each door latch increases, but only two door latches are provided on one side of the vehicle body, it is possible to increase the advantage of the package space.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating a state in which a door latch of an existing vehicle is provided on a vehicle body.

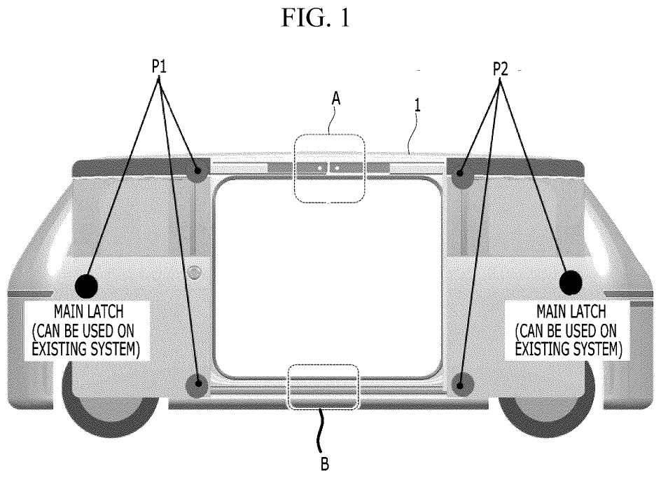

FIG. 2 is a diagram illustrating the state in which the door latch of the conventional vehicle is provided on the vehicle body between door drive units.

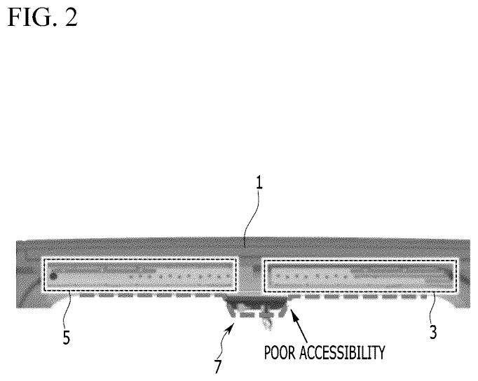

FIG. 3 is a diagram illustrating a structure of a door cinching latch in which an existing cinching motor is separately mounted.

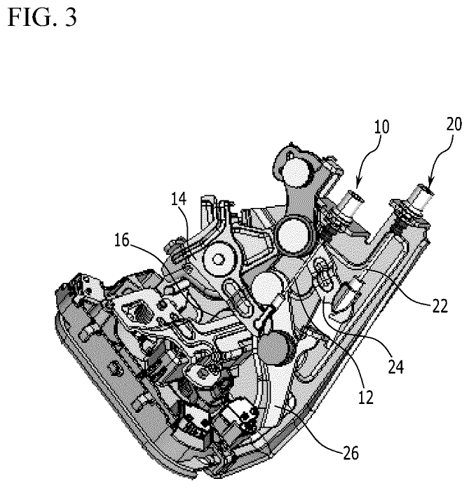

FIG. 4 is a diagram illustrating a structure of an existing cinching motor-integrated body E latch.

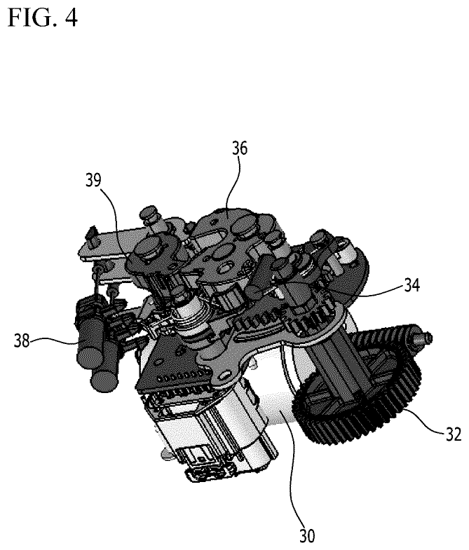

FIG. 5 is a diagram illustrating one surface of a door dual locking latch structure of a vehicle according to an exemplary embodiment of the present disclosure.

FIG. 6 is a view exemplarily illustrating the other surface of the door dual locking latch structure of a vehicle according to an exemplary embodiment of the present disclosure.

FIG. 7 is a diagram illustrating a 1-stage locking state when the door is closed in the dual door locking latch structure of a vehicle according to an exemplary embodiment of the present disclosure.

FIG. 8 is a diagram illustrating an operating state after the 1-stage locking when the door is closed in the dual door locking latch structure of a vehicle according to an exemplary embodiment of the present disclosure.

FIG. 9 is a diagram illustrating a 2-stage locking and cinching state when the door is closed in the dual door locking latch structure of a vehicle according to an exemplary embodiment of the present disclosure.

FIG. 10 is a diagram illustrating an unlocking (release) start state when the door is open in the dual door locking latch structure of a vehicle according to an exemplary embodiment of the present disclosure.

FIG. 11 is a diagram illustrating an unlocking complete state when the door is open in the dual door locking latch structure of a vehicle according to an exemplary embodiment of the present disclosure.

FIG. 12 is a diagram illustrating the unlocking start state by an emergency cable in an emergency situation of the dual door locking latch structure of a vehicle according to an exemplary embodiment of the present disclosure.

FIG. 13 is a diagram illustrating the unlocking complete state by the emergency cable in the emergency situation of the dual door locking latch structure of a vehicle according to an exemplary embodiment of the present disclosure.

FIG. 14 is a diagram sequentially illustrating the door dual locking latch structure of a vehicle and the operating state of the door according to an exemplary embodiment of the present disclosure when a front door and a rear door of the vehicle are open simultaneously.

FIG. 15 is a diagram sequentially illustrating the door dual locking latch structure of a vehicle and the operating state of the door according to an exemplary embodiment of the present disclosure when the front and rear doors of the vehicle are closed simultaneously.

FIG. 16 is a diagram sequentially illustrating the door dual locking latch structure of a vehicle and the operating state of the door according to an exemplary embodiment of the present disclosure when only the front door is open while the front and rear doors of the vehicle are closed.

FIG. 17 is a diagram sequentially illustrating the door dual locking latch structure of the vehicle and the operating state of the door according to an exemplary embodiment of the present disclosure when the rear door is open while only the front door of the vehicle is open.

FIG. 18 is a diagram sequentially illustrating the door dual locking latch structure of a vehicle and the operating state of the door according to an exemplary embodiment of the present disclosure when only the rear door is closed while the front and rear doors of the vehicle are open.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings so that those skilled in the art to which the present disclosure pertains may easily practice the present disclosure. However, the present disclosure may be implemented in various different forms and is not limited to exemplary embodiments provided herein.

Furthermore, in several exemplary embodiments of the present disclosure, components including the same configuration will be representatively described using the same reference numerals in an exemplary embodiment of the present disclosure, and only components different from those of an exemplary embodiment will be described in the other exemplary embodiments of the present disclosure.

Note that drawings are schematic and not drawn to scale. The relative dimensions and ratios of parts in the drawing are shown exaggerated or reduced in size for clarity and convenience in the drawing, and any dimensions are illustrative only and not limiting. In addition, the same reference sign is used to indicate similar features to the same structure, element or part appearing in the drawing of two or more. When a part is referred to as being “on” or “on” another part, it may be directly on top of the other part, or may be accompanied by the other part in between.

Exemplary embodiments represent an exemplary embodiment of the present disclosure. As a result, numerous variations of the illustration are expected. Accordingly, the exemplary embodiment of the present disclosure is not limited to a specific form of the illustrated area, and includes, for example, a deformation of the form by manufacturing.

Hereinafter, a dual locking door latch structure of a vehicle according to an exemplary embodiment of the present disclosure will be described in detail with reference to the accompanying drawings.

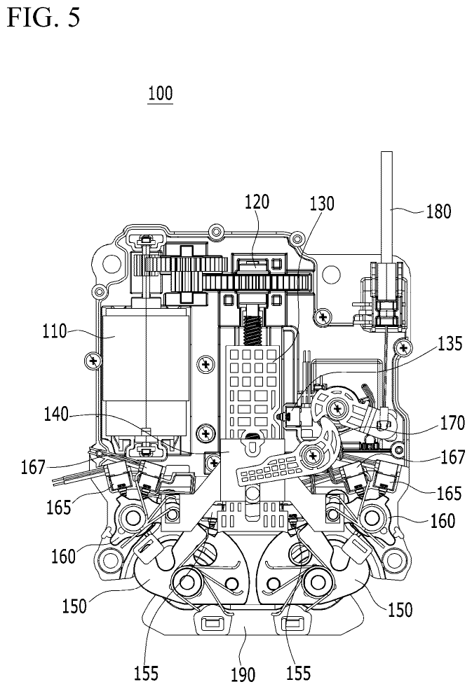

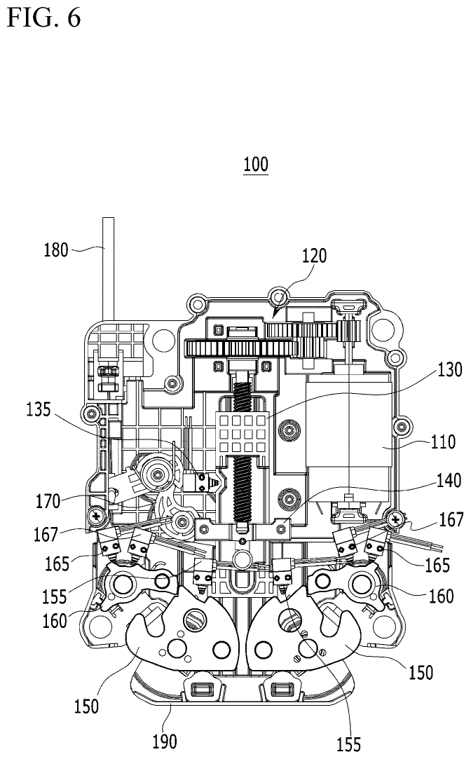

FIG. 5 is a diagram illustrating one surface of a door dual locking latch structure of a vehicle according to an exemplary embodiment of the present disclosure. FIG. 6 is a view exemplarily illustrating the other surface of the door dual locking latch structure of a vehicle according to an exemplary embodiment of the present disclosure.

Referring to FIG. 5 and FIG. 6, a dual locking door latch 100 structure of a vehicle according to an exemplary embodiment of the present disclosure may be one that, in the vehicle that opens or closes a door opening by sliding front and rear doors forwards and backwards in a longitudinal direction of the vehicle, the dual locking door latches 100 may be provided one by one on a vehicle body between the front and rear doors at upper and lower portions of the door opening. That is, in the entire vehicle, the dual locking door latch 100 may be composed of a total of four, two provided on left and right sides of the vehicle, respectively.

The dual locking door latch 100 structure of a vehicle according to an exemplary embodiment of the present disclosure includes a claw 150, a door pawl 160, a release lever 140, a lead lever assembly 130, and a motor 110, and a gear assembly 120.

The claw 150 rotates to be coupled to or decoupled from a striker 50 provided on a sliding door. The claws 150 have slit openings of a predetermined thickness into which the striker 50 is inserted, and are provided as a pair symmetrically disposed on both sides of the door latch 100.

The door pawl 160 operates to rotate the claw 150 by contacting or releasing from the contact with the claw 150 by rotation thereof. A step is formed in the claw 150 so that the door pawl 160 is contacted and supported, and an end portion of the door pawl 160 contacts with the step portion, so that when the door pawl 160 rotates, the door pawl 160 rotates the claw 150. Like the claws 150, the door pawls 160 are also provided as a pair symmetrically disposed on both sides of the door latch 100.

The release lever 140 is coupled to the door pawl 160 and operates to rotate the door pawl 160 while moving in a vertical direction of the door latch 100. The release lever 140 may extend symmetrically to both sides of the door latch 100. One end portion of the door pawl 160 is rotatably connected to both sides of the release lever 140, and when the release lever 140 moves in the vertical direction, the door pawl 160 with a fixed central axis may rotate.

The lead lever assembly 130 is coupled to the center portion of the release lever 140, and moves the release lever 140 in the vertical direction while moving in the vertical direction of the door latch 100 in the center portion of the door latch 100.

The motor 110 provides driving force so that the lead lever assembly 130 moves in the vertical direction thereof. To the present end, the motor 110 is connected to the gear assembly 120, the rotation force of the motor 110 is transmitted to the gear assembly 120, and as the gear assembly 120 rotates, the lead lever assembly 130 may move in the vertical direction thereof.

In the present way, the claw 150, the door pawl 160, and the release lever 140 are provided in pairs on both sides of the door latch 100 with the lead lever assembly 130 as the center, and may operate simultaneously by moving in the up and down directions.

Meanwhile, the release lever 140 may be further provided with an emergency link assembly 170. The emergency link assembly 170 is connected to an emergency cable 180, and the emergency cable 180 may be manually pulled in a direction away from the door latch 100.

The emergency cable 180 may be connected to an emergency lever provided separately on the exterior of the vehicle. A user may pull the emergency cable 180 by manipulating the emergency lever, and the emergency cable 180 may rotate the emergency link assembly 170 to move the lead lever assembly 130 upwards of the door latch 100.

The emergency link assembly 170 may be connected to the release lever 140, and may move the release lever 140 and the lead lever assembly 130 connected thereto upward by rotation thereof. When the emergency cable 180 is pulled, the emergency link assembly 170 rotates to move the release lever 140 upward, which causes the release lever 140 and the door pawl 160 to be released from contact. The door pawl 160 returns to its original position by elastic force, and the claw 150 is released.

Meanwhile, on one side of the door pawl 160, a reference (REF) switch 167 which is configured to detect a reference position of the door pawl 160, and a pawl switch 165 which is configured to detect the current position of the door pawl 160 may be provided.

Furthermore, a claw switch 155 may be provided on one side of the claw 150 to detect the current position of the claw 150, and a home pose switch 135 may be provided on one side of the lead lever assembly 130 to detect the current position of the lead lever assembly 130.

The claw 150 and the lead lever assembly 130 may be movably fixed to a base plate 190, and the base plate 190 may be fixed to the vehicle body.

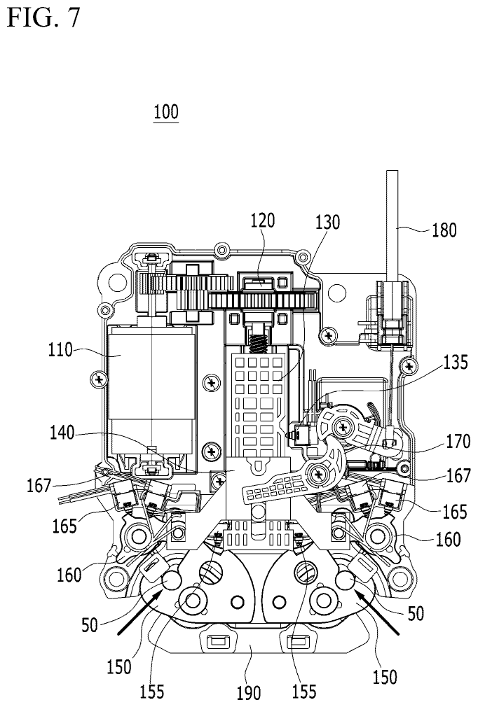

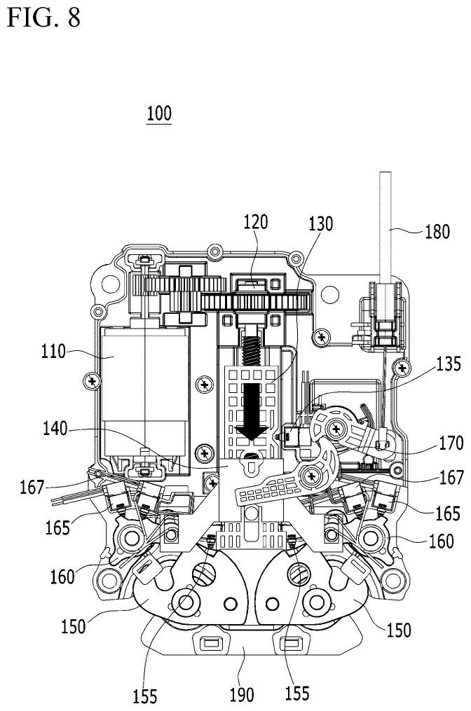

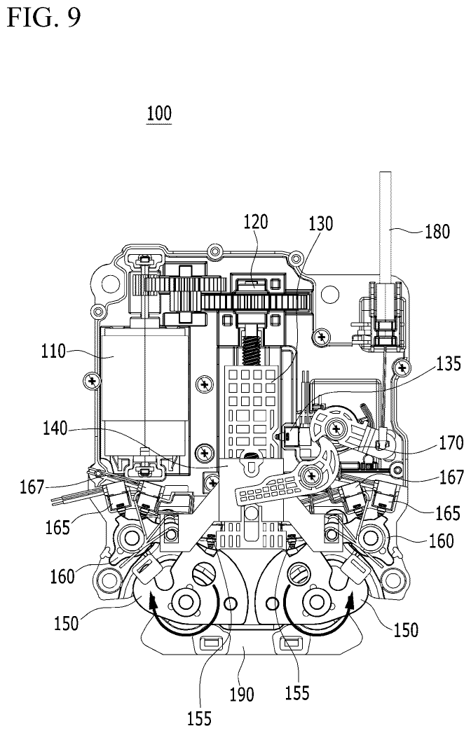

FIG. 7 is a diagram illustrating a 1-stage locking state when the door is closed in the dual door locking latch structure of a vehicle according to an exemplary embodiment of the present disclosure. FIG. 8 is a diagram illustrating an operating state after the 1-stage locking when the door is closed in the dual door locking latch structure of a vehicle according to an exemplary embodiment of the present disclosure. FIG. 9 is a diagram illustrating a 2-stage locking and cinching state when the door is closed in the dual door locking latch structure of a vehicle according to an exemplary embodiment of the present disclosure.

As illustrated in FIG. 7, when the door is open and a door closing signal is applied, the door slides by a door drive unit and moves toward the door latch 100, and the striker 50 provided on the door is coupled to the claw 150 to complete 1-stage locking.

Accordingly, as illustrated in FIG. 8, the motor 110 operates, the lead lever assembly 130 is lowered by the rotation of the gear assembly 120 connected to the motor 110, and the door pawl 160 rotates as the release lever 140 connected to the lead lever assembly 130 is lowered.

Accordingly, as illustrated in FIG. 9, the door pawl 160 contacts with the claw 150 while rotating, causing the claw 150 to rotate, and the claw 150 rotates to the 2-stage locking position to be cinched. When the 2-stage locking is detected to be completed, the cinching is stopped and the closing of the door is completed.

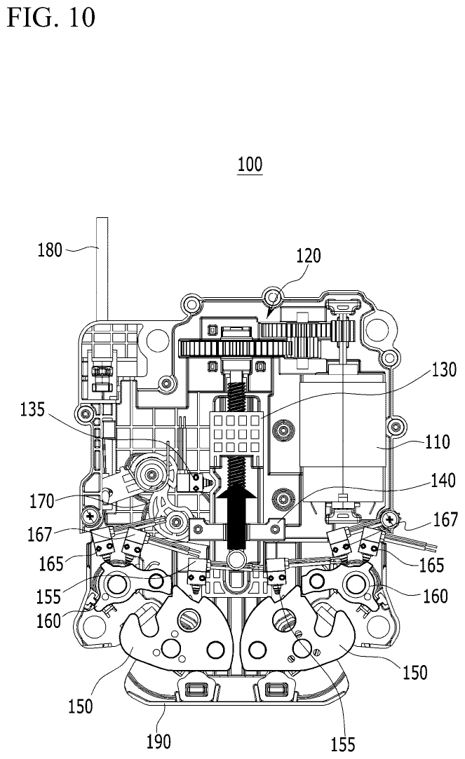

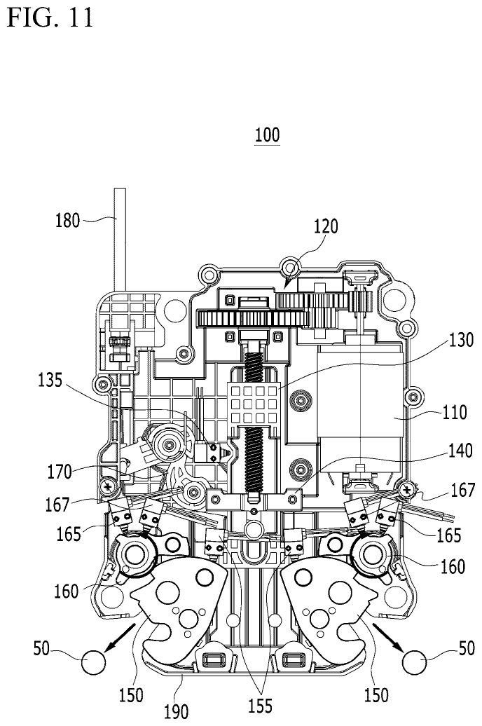

FIG. 10 is a diagram illustrating an unlocking (release) start state when the door is open in the dual door locking latch structure of a vehicle according to an exemplary embodiment of the present disclosure. FIG. 11 is a diagram illustrating an unlocking complete state when the door is open in the dual door locking latch structure of a vehicle according to an exemplary embodiment of the present disclosure.

As illustrated in FIG. 10, when a door opening signal (unlock signal) is received while the door is closed, the motor 110 operates, and by the rotation of the gear assembly 120 connected to the motor 110, the lead lever assembly 130 rises, and the release lever 140 connected to the lead lever assembly 130 rises.

Thereafter, as illustrated in FIG. 11, the door pawl 160 rotates as the release lever 140 rises. Accordingly, the door pawl 160 releases contact with the claw 150, and the claw 150 rotates to be decoupled from the striker 50. In the instant case, the claw 150 may return to its original position by elastic force when the contact with the door pawl 160 is released.

Accordingly, the door is decoupled from the door latch 100 and moves to both sides in the opened state by the door drive unit, so that the opening of the door is completed.

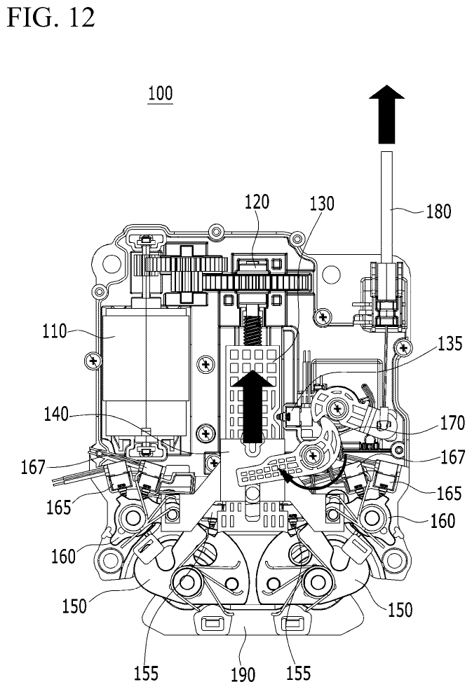

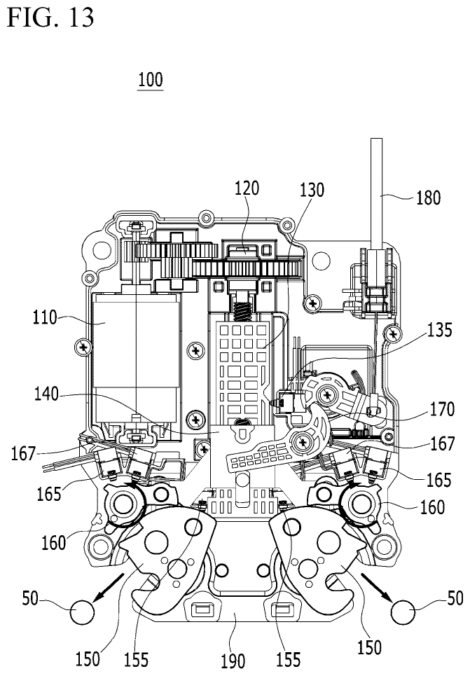

FIG. 12 is a diagram illustrating the unlocking start state by an emergency cable in an emergency situation of the dual door locking latch structure of a vehicle according to an exemplary embodiment of the present disclosure. FIG. 13 is a diagram illustrating the unlocking complete state by the emergency cable in an emergency situation of the dual door locking latch structure of a vehicle according to an exemplary embodiment of the present disclosure.

As illustrated in FIG. 12, in the door closed state, when a user manually pulls the emergency cable 180 in a direction away from the door latch 100 in the emergency situation of the vehicle, the emergency link assembly 170 rotates, and the lead lever assembly 130 may move upwards.

Thereafter, as illustrated in FIG. 13, the release lever 140 moves upward, and the door pawl 160 rotates by the movement of the release lever 140. The door pawl 160 releases the contact with the claw 150, and the coupling of the claw 150 to the striker 50 is released as the claw 150 rotates. Accordingly, the door is decoupled from the door latch 100 and manually moves to both sides in the opened state, so that the opening of the door is completed.

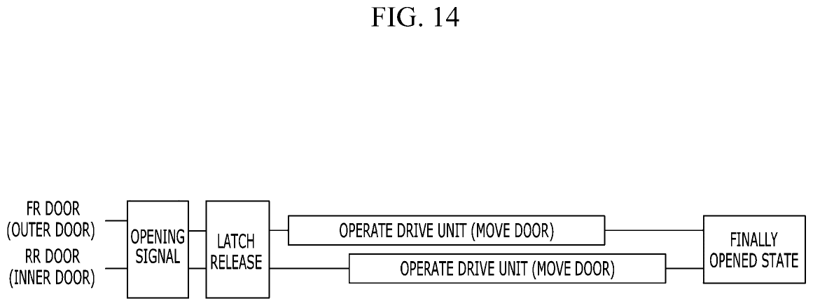

FIG. 14 is a diagram sequentially illustrating the door dual locking latch structure of a vehicle and the operating state of the door according to an exemplary embodiment of the present disclosure when a front door and a rear door of the vehicle are open simultaneously.

In an exemplary embodiment of the present disclosure, the operating state of the door in FIG. 14 may be performed by a controller operatively connected to the motor 110 and including a processor.

Referring to FIG. 14, when the front and rear doors of the vehicle are open simultaneously, if the opening signal is received, the motor 110 operates and by the rotation of the gear assembly 120 connected to the motor 110, the lead lever assembly 130 rises, and the release lever 140 connected to the lead lever assembly 130 rises. As the release lever 140 rises, the door pawl 160 rotates. Accordingly, the door pawl 160 releases the contact with the claw 150, and the claw 150 rotates to be decoupled from the striker 50 (latch release).

Thereafter, the front and rear doors moves by operation of the drive unit provided in each thereof, and the door is open. In the instant case, since the front and rear doors are open, the cinching process is not performed.

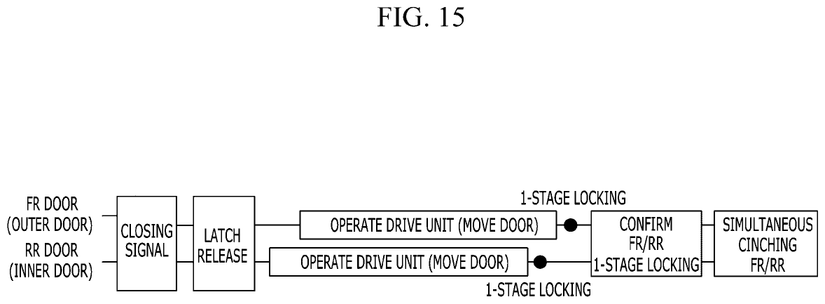

FIG. 15 is a diagram sequentially illustrating the door dual locking latch structure of a vehicle and the operating state of the door according to an exemplary embodiment of the present disclosure when the front door and the rear door of the vehicle are closed simultaneously.

In an exemplary embodiment of the present disclosure, the operating state of the door in FIG. 15 may be performed by a controller operatively connected to the motor 110 and including a processor.

Referring to FIG. 15, when the front and rear doors of the vehicle are closed simultaneously while being open, if the closing signal of the front and rear doors is received, the lead lever assembly 130 rises by operation of the motor 110, so that the claw 150 is decoupled from the striker 50 (latch release), and the door slides by the door drive unit and moves toward the door latch 100 and the striker 50 provided on the door is coupled to the claw 150, so that the 1-stage locking is completed.

Thereafter, the motor 110 operates to lower the lead lever assembly 130, the door pawl 160 rotates as the release lever 140 connected to the lead lever assembly 130 is lowered, and the cinching of the door is completed as the claw 150 rotates.

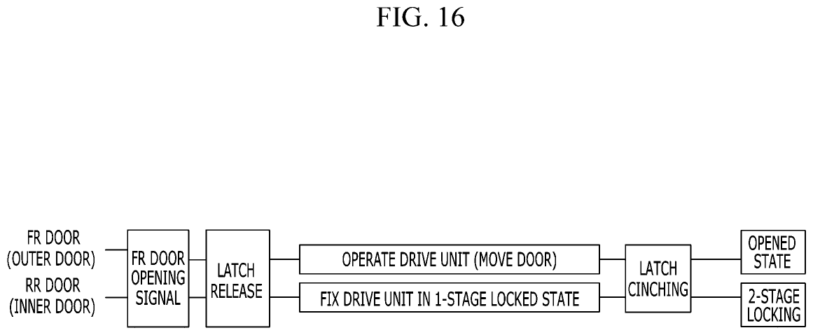

FIG. 16 is a diagram sequentially illustrating the door dual locking latch structure of a vehicle and the operating state of the door according to an exemplary embodiment of the present disclosure when only the front door is open while the front door and the rear door of the vehicle are closed.

In an exemplary embodiment of the present disclosure, the operating state of the door in FIG. 16 may be performed by a controller operatively connected to the motor 110 and including a processor.

Referring to FIG. 16, when the opening signal of the front door is received, the lead lever assembly 130 rises by operation of the motor 110 provided on the front and rear doors side, and the claw 150 rotates as the release lever 140 connected to the lead lever assembly 130 rises and is decoupled from the striker 50 (latch release).

Thereafter, the front door moves by the drive unit on the front door side to open the door opening, and the rear door side is fixed while maintaining the 1-stage locked state.

Thereafter, the motor 110 operates to lower the lead lever assembly 130, the door pawl 160 rotates as the release lever 140 connected to the lead lever assembly 130 is lowered, and the cinching of the door is completed as the claw 150 rotates. In the instant case, the rear door is in a 2-stage locked state, and the front door is in an opened state.

The example in FIG. 16 may be applied when only one door is open while two doors are closed, and may also be modified and applied even when only the rear door is open while the front and rear doors are closed.

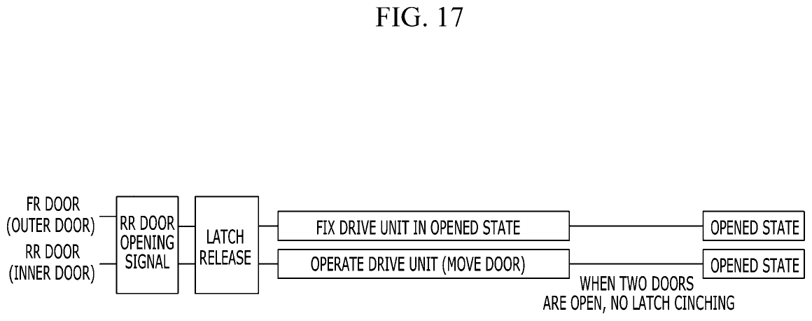

FIG. 17 is a diagram sequentially illustrating the door dual locking latch structure of the vehicle and the operating state of the door according to an exemplary embodiment of the present disclosure when the rear door is open while only the front door of the vehicle is open.

In an exemplary embodiment of the present disclosure, the operating state of the door in FIG. 17 may be performed by a controller operatively connected to the motor 110 and including a processor.

As illustrated in FIG. 17, when the rear door is open while only the front door of the vehicle is open, if the opening signal of the rear door is received, the lead lever assembly 130 rises by operation of the motor 110 provided on the front and rear doors side, and the claw 150 rotates as the release lever 140 connected to the lead lever assembly 130 rises and is decoupled from the striker 50 (latch release).

Thereafter, the front door is maintained in the opened state, and the rear door moves to the opened state by the drive unit, so that the opening of the door is completed. In the instant case, since the front and rear doors are open, the cinching process is not performed.

The example of FIG. 17 may be applied when the other doors are also open while one door is open, and may also be modified and applied even when only the rear door of the vehicle is open and the front door is open.

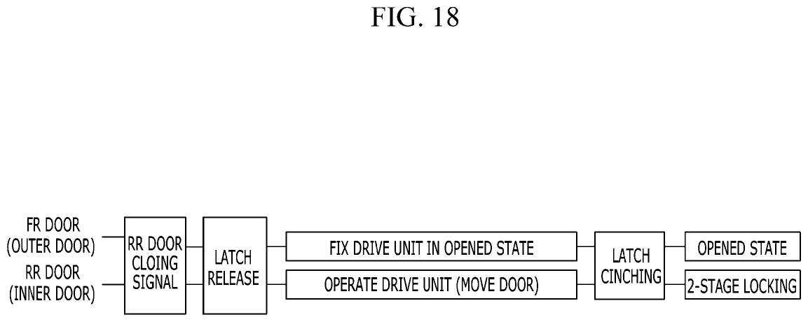

FIG. 18 is a diagram sequentially illustrating the door dual locking latch structure of a vehicle and the operating state of the door according to an exemplary embodiment of the present disclosure when only the rear door is closed while the front door and the rear door of the vehicle are open.

In an exemplary embodiment of the present disclosure, the operating state of the door in FIG. 18 may be performed by a controller operatively connected to the motor 110 and including a processor.

As illustrated in FIG. 18, when only the rear door is closed while the front and rear doors of the vehicle are open, if the closing signal of the rear door is received, the lead lever assembly 130 rises by operation of the motor 110 provided on the front and rear doors side, and the claw 150 rotates as the release lever 140 connected to the lead lever assembly 130 rises and is decoupled from the striker 50 (latch release).

Thereafter, the front door is maintained in the opened state, and the rear door moves to the closed state by the drive unit.

Thereafter, the striker 50 provided on the rear door is coupled to the claw 150 to be in the 1-stage locked state, the motor 110 operates to lower the lead lever assembly 130, the door pawl 160 rotates as the release lever 140 connected to the lead lever assembly 130 is lowered, and the cinching of the door is completed as the claw 150 rotates. Accordingly, the front door is maintained in the opened state, and the 2-stage locking of the rear door is completed.

The example in FIG. 18 may be applied when only one door is closed while two doors are open, and may also be modified and applied even when only the front door is closed while the front and rear doors are open.

As described above, according to an exemplary embodiment of the present disclosure, by providing the bi-directional dual locking door latch structure of minimized size on the vehicle body between the door drive units to cinch and release the bi-directional sliding door, the bi-directional dual locking door latch structure may be composed of four door latches compared to the existing eight door latches, so it is possible to reduce the material costs and reduce the thickness and weight.

Furthermore, since the size of each door latch increases, but only two door latches are provided on one side of the vehicle body, it is possible to increase the advantage of the package space.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A dual locking door latch structure of a vehicle, which is provided on a vehicle body to open or close a door configured to open or close a door opening of the vehicle, and is provided to be coupled to or decoupled from the door, the dual locking door latch structure comprising:
a claw rotating to be coupled to or decoupled from a striker provided on the door;
a door pawl operating to rotate the claw by contacting or releasing the contact with the claw by the rotation;
a release lever coupled to the door pawl and operating to rotate the door pawl by up and down movement of the release lever;
a lead lever assembly coupled to the release lever and moving the release lever in up and down directions;
a motor providing driving force to the lead lever assembly for the up and down movement of the lead lever assembly; and
a gear assembly engaged between the motor and the lead lever assembly and transmitting the driving force provided by the motor to the lead lever assembly,
wherein the claw, the door pawl, and the release lever are provided in pairs on first and second sides of the lead lever assembly, respectively, and operate simultaneously.

2. The dual locking door latch structure of claim 1, wherein the release lever is attached to a center portion of the lead lever assembly, extends to the first and second sides of the lead lever assembly, and is connected to the door pawl.

3. The dual locking door latch structure of claim 1, further including:
an emergency link assembly connected to the release lever and rotating the release lever and the lead lever assembly upward by the rotation.

4. The dual locking door latch structure of claim 3, wherein the emergency link assembly is connected to an emergency cable for manual operation thereof.

5. The dual locking door latch structure of claim 4, wherein the emergency cable is connected to an emergency lever separately provided on an exterior of the vehicle.

6. The dual locking door latch structure of claim 1, wherein one side of the door pawl is provided with a reference (REF) switch which is configured to detect a reference position of the door pawl and a pawl switch which is configured to detect a current position of the door pawl.

7. The dual locking door latch structure of claim 1, wherein one side of the claw is provided with a claw switch which is configured to detect a current position of the claw.

8. The dual locking door latch structure of claim 1, wherein one side of the lead lever assembly is provided with a home pose switch which is configured to detect a current position of the lead lever assembly.

9. The dual locking door latch structure of claim 1, wherein the claw and the lead lever assembly are movably fixed to a base plate.

10. The dual locking door latch structure of claim 1, wherein in response that the door is closed, the striker is coupled to the claw to be in 1-stage locking, the lead lever assembly is lowered by operation of the motor and the door pawl rotates by the release lever, and the door pawl contacts with the claw and operates so that the claw rotates and cinches.

11. The dual locking door latch structure of claim 1, wherein in response that the door is open and an unlock signal is received, the lead lever assembly moves upward by operation of the motor, and the door pawl rotates by the release lever, and in response that the door pawl releases the contact with the claw and the claw rotates, the claw is decoupled from the striker.

12. The dual locking door latch structure of claim 11, wherein in response that the claw releases the contact with the door pawl, the claw returns to an original position thereof by elastic force.

13. The dual locking door latch structure of claim 4, wherein in response that the emergency cable is pulled upward, the emergency link assembly rotates to move the lead lever assembly upward, and the door pawl rotates by the release lever, and the door pawl releases the contact with the claw and the claw rotates so that the claw is decoupled from the striker.

14. The dual locking door latch structure of claim 1, wherein the dual locking door latch structure of the vehicle is provided at upper and lower portions of the vehicle body of the door opening to be coupled to or decoupled from front and rear doors of the vehicle, respectively, and the front and rear doors are provided to open or close simultaneously or separately.

15. The dual locking door latch structure of claim 14, wherein in response that the front and rear doors of the vehicle are open simultaneously, and an opening signal is received, the claw is decoupled from the striker by operation of the motor, and the front and rear doors move by operation of drive units provided in each thereof so that the door opening is open.

16. The dual locking door latch structure of claim 14, wherein in response that the front and rear doors of the vehicle are closed simultaneously, and a closing signal of the front and rear doors is received, the claw is decoupled from the striker by operation of the motor, the front and rear doors move by operation of the drive units provided in each thereof so that the door opening is closed, the strikers provided on the front and rear doors, respectively, are coupled to the claw to be in 1-stage locking, and the claw rotates by operation of the motor and is simultaneously cinched.

17. The dual locking door latch structure of claim 14, wherein in response that only the front door is open while the front and rear doors of the vehicle are closed, and an opening signal of the front door is received, the claw is decoupled from the striker by operation of the motor provided on the front and rear doors, the door opening is open by moving by operation of the drive unit on the front door side, and the claw operates to rotate by operation of the motor.

18. The dual locking door latch structure of claim 14, wherein in response that the rear door is open while only the front door of the vehicle is open, and an opening signal of the rear door is received, the claw is decoupled from the striker by operation of the motor provided on the front and rear doors, and the door opening is open by operation of the drive unit on the rear door side.

19. The dual locking door latch structure of claim 14, wherein in response that only the rear door is closed while the front and rear doors of the vehicle are open, and a closing signal of the rear door is received, the claw is decoupled from the striker by operation of the motor provided on the front and rear doors, the door opening moves by operation of the drive unit on the rear door side so that the door opening is closed, the striker provided on the rear door is coupled to the claw to be in 1-stage locking, and the claw rotates by operation of the motor and is simultaneously cinched.
